(19) United States
(12) Patent Application Publication
(10) Pub. No.: US 2006/0245577 A1
(43) Pub. Date: Nov. 2, 2006

(54) System and method for providing agent directed automatic call backs

(75) Inventors: Richard Mancuso, Elmhurst, IL (US); Mark Michelson, Elburn, IL (US); Sales Kalayil, Glen Ellyn, IL (US); Judith Laughlin, Covington, WA (US); Michael Frediani, Plainfield, IL (US)

Correspondence Address: WELSH & KATZ, LTD, 120 S RIVERSIDE PLAZA, 22ND FLOOR, CHICAGO, IL, 60606, US

(73) Assignee: Rockwell Electronic Commerce Technologies, LLC, Wood Dale, IL (US)

(21) Appl. No.: 11/115,517

(22) Filed: Apr. 27, 2005

(51) Int. Cl. H04M 3/00

(52) U.S. Cl. 379/265.02

(57) ABSTRACT

A method and system of providing an agent directed automatic call back to a customer in a call center is presented. A screen display is established on an agent's computer, the screen display requests call back information on the customer. The call back information includes a work key identifier and/or an application identifier. The agent manually inputs at least some of the call back information. The call back information is coupled via a call center network into a computer system associated with a telephone switching system. A call back time is scheduled and the computer system instructs the telephone switching system to automatically place the automatic call back at the call back time.

### FIELD OF THE INVENTION

The present invention relates generally to customer contact handling systems and more particularly to a method and system for generating agent directed automatic call backs to customers.

### BACKGROUND

A call center is a business unit that uses groups of agents or telephone representatives to handle a variety of customer contacts (i.e. different types of media transactions) often over the phone. Whether a business is large or small, call center automation provides a business advantage through increased customer satisfaction, increased productivity and revenues, and reduced operating costs.

Business applications for call centers accommodate a wide variety of transactions. Call centers can support, for example, sales, including order entry, order inquiry, and reservations; financial services, including funds transfer credit card verification and stock transactions; information services, including event schedules, referral services, transportation schedules, and yellow pages; and customer services, including technical support, repair dispatch, and claims handling.

A call center typically employs a number of agents who service customers of the call center, also often referred as a contact center, using a number of communication channels or transport mechanisms, which may be of a single type or of varying types. Examples of such transport mechanisms include the public switched telephone network (PTSN) and associated telephone trunk lines, the Internet and other packet transfer connections, cellular telephone systems, satellite communications systems, cable communication systems, etc. In order for a call center to be successful, it needs to communicate efficiently with its customers. The term “call” in a call center refers not only to telephone calls, but may include other types of media including facsimile, e-mail, VOIP, etc.

Sometimes, however, a transaction with a customer cannot be completed during the present interaction with the customer, requiring that an agent would need to call back the customer at a later time. For example, while transacting business with customers with either voice calls or other media transactions, agents in call centers have often needed to make calls to third parties who are involved in or relevant to the current transaction. If the agent could not make contact with the third party in that attempt, the agent would need to call the customer back at a later time. Previously, only a manual process was in place which required the agent to keep track of the customer's phone information and remember to manually complete the call in order for the customer to be called back. If the agent forgot about the call or became to busy, the customer would not be called back. This could cause the call center to end up losing that customer's business. Furthermore, only the original agent involved would be responsible for making the call back even though there are usually other agents with the same skill sets who would also be able to handle the call. This prevents a call center from being able to effectively use all of its agent resources at the call center.

Agents also may need to be aware of what time they make their call back attempts in order to keep from violating time zone rules. Previous automatic call back systems did not have a procedure in which the system could automatically check the time zone of the customer and ensure that the customer is not called outside of the time zone rules.

### SUMMARY

In one embodiment, a method of providing an agent directed automatic call back to a customer in a call center is presented. A screen display is established on an agent's computer, the screen display requests call back information on the customer. The call back information includes a work key identifier and/or an application identifier. The agent manually inputs at least some of the call back information. The call back information is coupled via a call center network into a computer system associated with a telephone switching system. A call back time is scheduled and the computer system instructs the telephone switching system to automatically place the automatic call back at the call back time.

### BRIEF DESCRIPTION OF THE DRAWINGS

The invention, together with the advantages thereof, may be understood by reference to the following description in conjunction with the accompanying figures, which illustrate some embodiments of the invention.

FIG. 1 is a functional block diagram illustrating one embodiment of a system for establishing agent directed call backs.

FIG. 2 is an example of one embodiment of a web form that can be used to input the call back information.

FIG. 3 is a flowchart of one example of a schedule check process.

### DETAILED DESCRIPTION

While the present invention is susceptible of embodiments in various forms, there is shown in the drawings and will hereinafter be described exemplary embodiments with the understanding that this disclosure is not intended to limit the invention to the specific embodiments illustrated.

It should be further understood that the title of this specification section, namely, “Detailed Description”, relates to a requirement of the United States Patent Office, and does not imply, nor should it be inferred to limit the subject matter disclosed herein.

In the present disclosure, the use of the disjunctive is intended to include the conjunctive. The use of the definite article or indefinite article is not intended to indicate cardinality. In particular, a reference to “the” object or “a” object is also intended to denote a possible plurality of such objects.

From the foregoing it will be observed that numerous modifications and variations can be effectuated without departing from the true spirit and scope of the novel concepts disclosed herein. It is to be understood that no limitation with respect to the specific embodiments illustrated is intended or should be inferred. The disclosure is intended to cover by the appended claims all such modifications as fall within the scope of the claims.

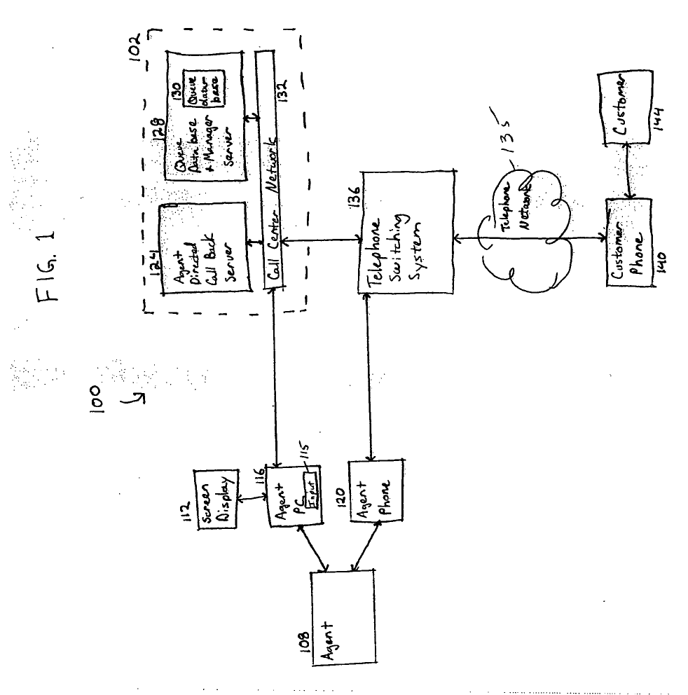

FIG. 1, a functional block diagram, illustrates one embodiment of a call center system 100 for establishing agent directed call backs. One embodiment of such a system 100, as shown in FIG. 1, consists of a computer system 102, a telephone switching system 136 connected to the computer system 102, one or more agents 108, each agent 108 having a PC 116 that is connected to the computer system 102, and a phone 120 that is connected to the telephone switching system 136. Customers 144 may, for example, call into the system 100 using customer phone 140 for connection through a telephone network 135 to the telephone switching system 136.

In operation, if the agent 108 needs to schedule a call back because a third party was unavailable, or for some other reason, the agent 108 enters the call back information on a screen display 112 presented on the agent's PC 116 using an input device 115 such as a keyboard mouse, etc. The information from the screen display 112 is inserted into the computer system 102. At a later time, the computer system 102 then instructs the telephone switching system 136 to attempt the automatic call back to the customer according to the information entered into the screen display 112.

In one embodiment, the computer system 102 consists of a call center computer network 132, such as an ethernet; an agent directed call back server 124; and a queue database and manager server 128, such as Rockwell International's Queue Optimizer including a queue database 130. A designated server, such as the agent directed call back server 124 can be used to generate the screen display 112 to be presented on the agent's PC 116. The functions of the computer system 102 may be implemented with software and a wide variety of architectures composed of one or more computers and/or other hardware.

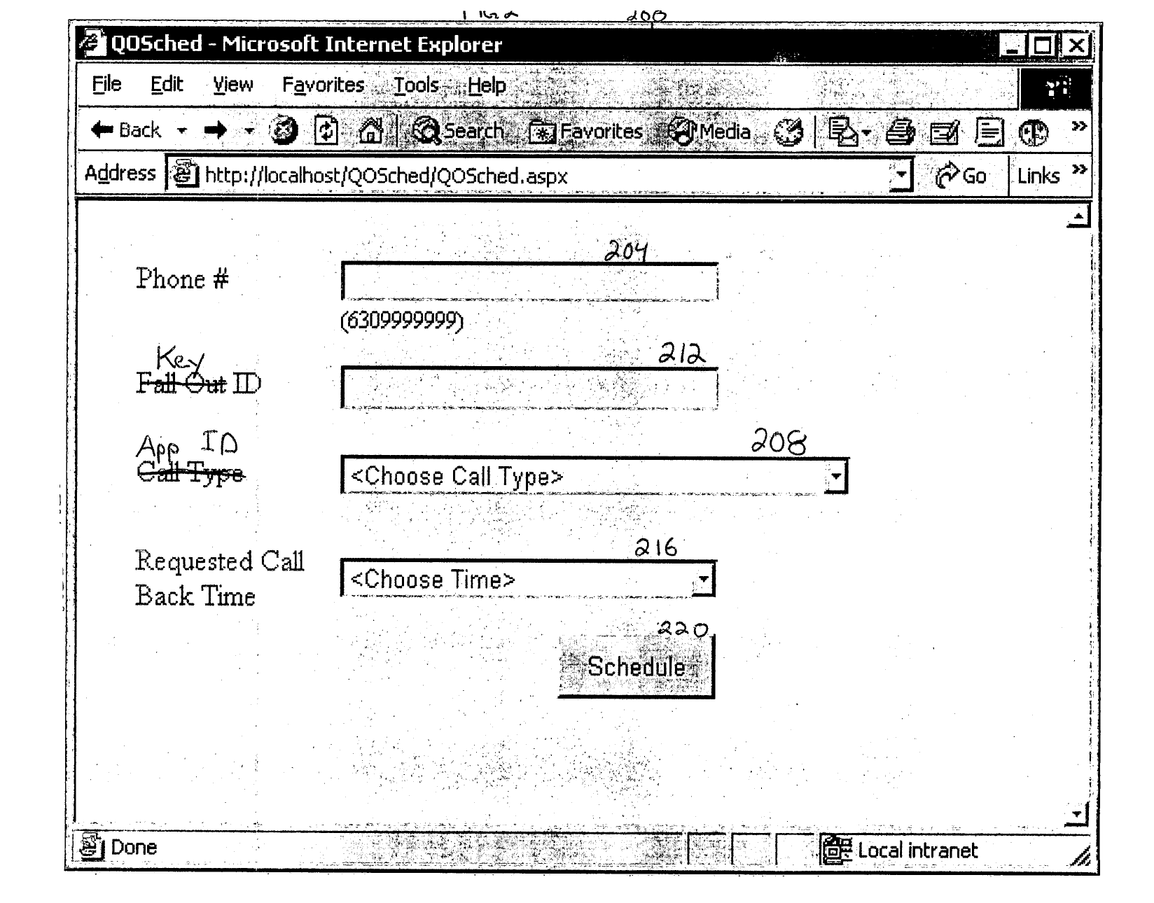

As shown in FIG. 2, an example of a web form 200 is illustrated which can be used as the screen display 112. The web form 200 may be used to display the information on the customer that needs to be entered by the agent. This information may include, for example, the customer's phone number 204, a work key identifier 212, an application identifier 208, and a time 216 for the call back to be scheduled. The application identifier 208 can be used to route the call to the proper support group. For example, if the automatic call back is being scheduled because the customer has a question about billing, the application identifier 208 can be used to route the call to the agents that handle calls about billing. The work key identifier 212 can be used to contain information about the specific call back that is being scheduled. For example, the work key identifier 212 could contain information on the customer's specific problem. After the web form 200 is completed, the agent in the illustrated example can click a submit button 220 and the phone record is entered into the computer system 102.

After the call back information has been entered though the screen display 112, the information can be inserted into the queue database 130 located in the queue database and manager server 128. In one embodiment of the queue database and manager 128, the information may be inserted into a table and then record keys inserted into the table to enable delete procedures. The record keys allow the computer system to recognize whether a customer has called before the scheduled time of the automatic call back. Thus, if a customer calls in prior to the scheduled automatic call back, the call back record can be removed from the queue so that the customer is not called again.

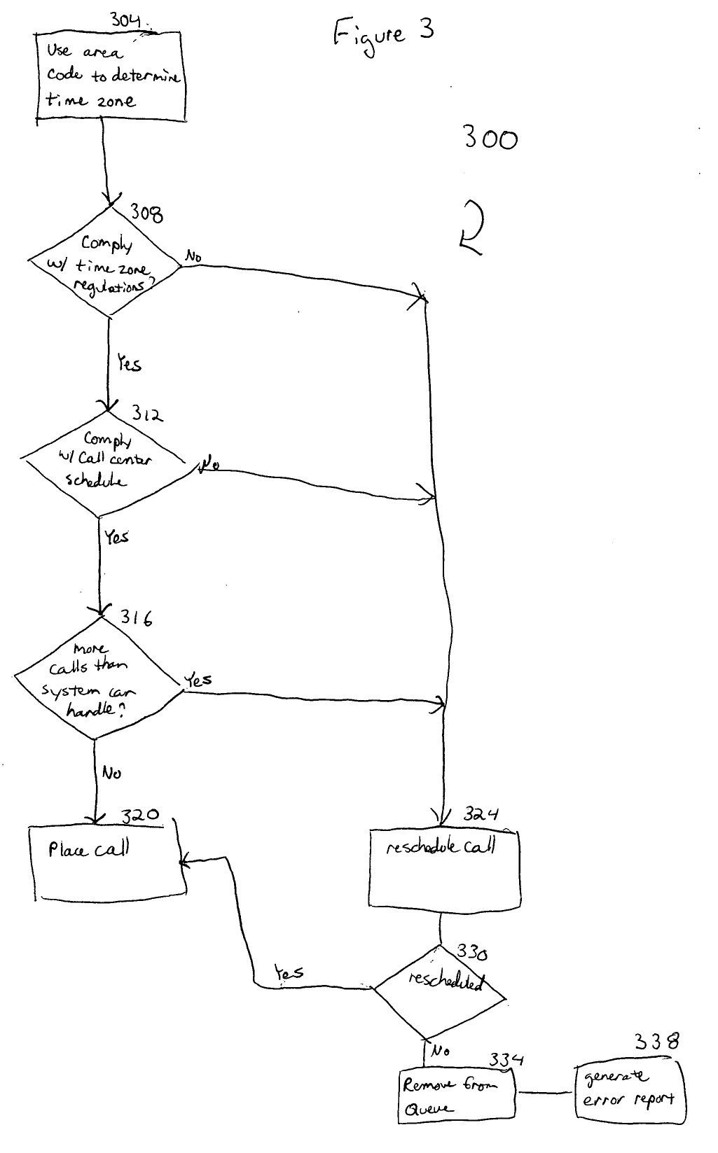

In one embodiment, the phone record can activate a schedule check process 300 as shown in the flow chart of FIG. 3. In the schedule check process, an area code of the customer is used to determine the time zone of the customer as illustrated at block 304. Then the call back record is checked against three different applications to determine whether the time entered for the call back is valid as illustrated at blocks 308, 312, and 316. The first application 308 checks to see if the call back time complies with time zone regulations and the second application 312 checks to see if the scheduled call back time complies with the call center's schedule. The third application 316 will check the number of calls scheduled at the time to ensure that the number isn't more than the system can handle. If the record passes these three application checks then the call will be attempted at the scheduled time 320. If the record does not pass any one of the application checks, the process will then attempt to reschedule the call back as illustrated in block 324. This is accomplished by attempting to find the next available time that passes all three application checks. If the rescheduling is successful the call back information is placed the queue as illustrated in block 330. If the process cannot reschedule the call the call back is removed from the queue, block 334, and an error report can then be generated 338. In one embodiment, the call back will be removed from the queue if the call back cannot be rescheduled in one week. The call back can also be removed from the queue if the number of retry attempts exceeds a specified number. This specified number for the maximum number of retry attempts can be set by the call center.

In one embodiment, once the scheduled call back time is reached, an instruction is sent to the telephone switching system 136 to attempt the call back to the customer 144. The telephone switching system 136 can be an automatic call distributor (ACD), such as Rockwell International's Spectrum ACD, a private branch exchange (PBX), or any other system available for initiating a call back. In one embodiment, once the scheduled call back time is reached and the call back record has passed the schedule check process 300, the queue database and manager 128 inserts the call back into an ACD queue. The ACD then attempts the call back. If the disposition of the callback is not a live disposition (e.g. an answering device), the call back can be rescheduled. The rescheduling can be based a time interval which can be determined by the call center. For example, the call center can set the rescheduling time interval so that the call is rescheduled for one hour or one day. Also, the rescheduled time can then go through the schedule check process again. In one embodiment, the call center can specify a maximum number of call back rescheduling attempts. When, the number of rescheduling attempts exceed the maximum specified be the call center the call back is removed from the queue. Otherwise, the ACD will connect the customer to the agent with the appropriate skill set. A similar process can also be used if the telephone switching system is a PBX.

Specific embodiments of methods and systems for providing agent directed call backs have been described for the purpose of illustrating the manner in which the invention is made and used. It should be understood that the implementation of other variations and modifications will be apparent to those of skill in the art, and that the invention is not limited to the specific embodiments described. It is contemplated to cover any and all modifications, variations, and equivalents that fall within the scope of the disclosure and claims herein.

1. A method of providing an agent directed automatic call back to a customer in a call center comprising:
establishing a screen display on an agent's computer, the screen display requesting call back information on the customer, the call back information having at least one of a work key identifier and an application identifier;
receiving by manual input from the agent at least some of the call back information;
coupling the call back information via a call center network into a computer system associated with a telephone switching system;
scheduling, using the computer system, a call back time for the automatic call back; and
instructing, via the computer system, the telephone switching system to automatically place the automatic call back at the call back time.

2. The method of claim 1 further comprising:
requesting a customer phone number from the customer, the number being a phone number used to contact the customer and having an area code;
automatically determining a time zone for the customer based upon the area code;
providing time zone regulations for the time zone; and
automatically determining that the call back time complies with the time zone regulations.

3. The method of claim 2 further comprising:
providing a call center schedule; and
automatically checking the call back time to ensure it complies with the call center schedule.

4. The method of claim 3 further comprising:
specifying a maximum number of calls scheduled at one time;
providing a count of calls scheduled at one time, the count of calls being a total number of all calls that are scheduled at the call back time;
automatically checking the count of calls scheduled at one time to ensure it is not greater than the maximum number of calls scheduled at one time.

5. The method of claim 4 further comprising:
attempting to complete the call back to the customer;
automatically rescheduling the call back for a predetermined time interval if the call back does not result in a live disposition.

6. The method of claim 1 wherein the information comprises the customers phone number, a work key identifier, an application identifier, and a time to complete the automatic call back.

7. A computer readable medium having encoded therein computer executable instructions for performing a method of providing an agent directed automatic call back to a customer in a call center, the method comprising:
establishing a screen display on an agent's computer, the screen display requesting call back information on the customer, the call back information having at least one of a work key identifier and an application identifier;
receiving by manual input from the agent at least some of the call back information;
coupling the call back information via a call center network into a computer system associated with a telephone switching system;
scheduling, using the computer system, a call back time for the automatic call back; and
instructing, via the computer system, the telephone switching system to automatically place the automatic call back at the call back time.

8. The computer readable medium having computer executable instructions for performing the method for providing an agent directed automatic call back as in claim 7, the method further comprising:
requesting a customer phone number from the customer, the number being a phone number used to contact the customer and having an area code;
automatically determining a time zone for the customer based upon the area code;
providing time zone regulations for the time zone; and
automatically determining that the call back time complies with the time zone regulations.

9. The computer readable medium having computer executable instructions for performing the method for providing an agent directed automatic call back as in claim 8, the method further comprising:
providing a call center schedule; and
automatically checking the call back time to ensure it complies with the call center schedule.

10. The computer readable medium having computer executable instructions for performing the method for providing an agent directed automatic call back as in claim 9, the method further comprising:
specifying a maximum number of calls scheduled at one time;
providing a count of calls scheduled at one time, the count of calls being a total number of all calls that are scheduled at the call back time;
automatically checking the count of calls scheduled at one time to ensure it is not greater than the maximum number of calls scheduled at one time.

11. The computer readable medium having computer executable instructions for performing the method for providing an agent directed automatic call back as in claim 7 wherein the information comprises the customer phone number, a work key identifier, an application identifier, and a time to complete the automatic call back.

12. A system for providing an agent directed automatic call back to a customer comprising:
at least one agent PC, each PC connected to a computer system;
a telephone switching system, the telephone switching system connected to the computer system;
an agent phone connected to the telephone switching system; and
the computer system, the computer system comprising a server for generating a screen display on the agent PC, an input device for the agent to manually enter call back information, and the screen display requesting the call back information, the call back information having at least one of a work key identifier and an application identifier.

13. The system in claim 12 wherein the screen display is a web form.

14. The system in claim 13 in which the computer system further comprises a second server, in which the second server is used to manage and store a queue database.

15. The system in claim 14 in which the computer system further comprises a network, the network connected to the servers, the agent PC, and the telephone switching system.

16. A system for providing an agent directed automatic call back to a customer comprising:
means for establishing a screen display on an agent's computer, the screen display requesting call back information on the customer, the call back information having at least one of a work key identifier and an application identifier;
means for receiving by manual input from the agent at least some of the call back information;
means for coupling the call back information via a call center network into a computer system associated with a telephone switching system;
means for scheduling, using the computer system, a call back time for the automatic call back; and
means for instructing, via the computer system, the telephone switching system to automatically place the automatic call back at the call back time.

17. The system in claim 16 further comprising:
means for requesting a customer phone number from the customer, the number being a phone number used to contact the customer and having an area code;
means for automatically determining a time zone for the customer based upon the area code;
means for providing time zone regulations for the time zone; and
means for automatically determining that the call back time complies with the time zone regulations.

18. The system in claim 17 further comprising:
means for providing a call center schedule; and
means for automatically checking the call back time to ensure it complies with the call center schedule.

19. The system in claim 18 further comprising:
means for specifying a maximum number of calls scheduled at one time;
means for providing a count of calls scheduled at one time, the count of calls being a total number of all calls that are scheduled at the call back time;
means for automatically checking the count of calls scheduled at one time to ensure it is not greater than the maximum number of calls scheduled at one time.

20. The system in claim 16 wherein the information comprises the customer phone number, a work key identifier, an application identifier, and a time to complete the automatic call back.
